(19) United States
(12) Patent Application Publication
(10) Pub. No.: US 2017/0038349 A1
(43) Pub. Date: Feb. 9, 2017

(54) PLATE FOR GAS CHROMATOGRAPH WITH A CAPILLARY COLUMN, CAPILLARY DEVICE AND GAS CHROMATOGRAPH

(71) Applicant: TOTAL SA, Courbevoie (FR)

(72) Inventor: Daniel Dessort, Doha (QA)

(21) Appl. No.: 15/100,123

(22) PCT Filed: Nov. 24, 2014
(86) PCT No.: PCT/EP2014/075440

§ 371 Date: May 27, 2016

(30) Foreign Application Priority Data
Nov. 27, 2013 (GC) 2013-25869

(51) Int. Cl. G01N 30/60

(52) U.S. Cl. CPC G01N 30/6043; G01N 2030/025

(57) ABSTRACT

The present invention relates to gas chromatography with capillary column and more particularly to a plate for gas chromatograph with a capillary column, a capillary device and a gas chromatograph comprising such capillary device. At least one face of the plate is etched with a furrow forming a first part of the capillary column. The capillary device 4 comprises at least two planes closely stacked with each other to form the capillary column of the gas chromatograph. The capillary device thus provided has advantageously reduced dimensions with respect to a laboratory gas chromatograph and a capillary column with conventional dimensions with respect to a laboratory gas chromatograph.

### RELATED APPLICATIONS

The present application is a National Phase entry of PCT Application No.

PCT/EP2014/075440, filed Nov. 24, 2014, which claims priority from GC Patent Application 2013-25869, filed Nov. 27, 2013, said applications being hereby incorporated by reference herein in their entirety.

### FIELD OF THE INVENTION

The present invention relates to gas chromatography with capillary column.

The present invention more particularly relates to a plate for gas chromatograph with a capillary column, a capillary device and a gas chromatograph comprising such capillary device.

### BACKGROUND OF THE INVENTION

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section. Furthermore, all embodiments are not necessarily intended to solve all or even any of the problems brought forward in this section.

Gas chromatography consists in a process of separating the compounds of a mixture, the process being carried out between a stationary phase and a mobile phase. Analysis methods by gas chromatography with capillary column, in particular intended for analyzing complex hydrocarbon mixtures, exist that are implemented with a laboratory gas chromatograph.

The laboratory gas chromatograph advantageously comprises a capillary column of sufficient length and diameter for allowing analysis of complex hydrocarbon mixtures, more particularly a mixture of hydrocarbons from C1 to C40+ (oils, petroleum, polycyclic aromatic hydrocarbons (PAHs), etc.). Such a column is approximately of a length of 25 to 100 m. Nonetheless, the conventional laboratory gas chromatograph is heavy—it weighs approximately 50 kg—and the capillary column has to be supported by a casing intended to be inserted in an oven which has to be of high volume, i.e. a volume of the order of a few cubic decimeters. Thus, such a laboratory gas chromatograph is neither mobile nor easily deployable on-site.

There is thus a need for a portable gas chromatograph having preferably performances similar to those of a laboratory gas chromatograph.

### SUMMARY OF THE INVENTION

According to a first aspect, the invention relates to a plate for gas chromatograph with a capillary column wherein at least one face of the plate is etched with a furrow forming a first part of the capillary column.

Owing to the basic piece formed by such a plate, a capillary device may be formed which has advantageously reduced dimensions with respect to a laboratory gas chromatograph and a capillary column with conventional dimensions with respect to a laboratory gas chromatograph.

In one embodiment, a plurality of unconnected furrows is etched on the same face of the plate, each furrow forming a first part of a capillary column.

According to a special feature, each furrow has a sinuosity index which is strictly greater than 1.

According to another special feature, a transversal section of each furrow has a greater internal dimension between 100 and 500 μm.

According to another special feature, the plate has a greater dimension between 1 and 10 cm.

According to another special feature, each furrow extends by a hole through the plate, each hole forming a part of the capillary column.

According to another special feature, at least each furrow is coated with a film of stationary phase. According to a variant of this special feature, the stationary phase can be chemically bonded to the inner surface of the furrow.

According to a variant of the previous special feature, the plate is made of a material thermostable at least at a pyrolysis temperature of the stationary phase.

According to another special feature, the plate is made of a material having a coefficient of thermal expansion less than the one of the stainless steel.

Another aspect of the invention relates to a capillary device comprising a first plate according to the first aspect of the invention and a second plate, wherein an etched face of the first plate is in contact with a face of the second plate, at least one portion of said face of the second plate forming a second part of each capillary column.

A capillary device is thus provided which has advantageously reduced dimensions with respect to a laboratory gas chromatograph and a capillary column with conventional dimensions with respect to a laboratory gas chromatograph.

According to a special feature, at least the second part of each capillary column is coated with a film of stationary phase. According to a variant of this special feature, the stationary phase can be chemically bonded to the inner surface of the furrow.

According to a special feature, the first plate and the second plate of the device are closely joined so that each capillary column is transversally tight to a carrier gas (nitrogen, helium or hydrogen).

According to a special feature, at least one furrow of the edged face of the first plate extending by a hole at least through the first plate, said hole joins a furrow etched on a face of the second plate.

According to a variant of the previous special feature, the transversal section of each hole has a greater internal dimension between 100 and 500 μm and wherein an internal surface of each hole is coated with a film of stationary phase. According to a variant of this special feature, the stationary phase can be chemically bonded to the inner surface of the hole.

Yet another aspect of the invention relates to a gas chromatograph comprising a capillary device according to the second aspect of the invention.

Such a gas chromatograph takes advantage of the reduced dimensions of the capillary device to be at the same time portable and capable of the same analysis capabilities than a laboratory gas chromatograph.

Other features and advantages of the plate for gas chromatograph with a capillary column, the capillary device and the gas chromatograph disclosed herein will become apparent from the following description of non-limiting embodiments, with reference to the appended drawings.

### BRIEF DESCRIPTION OF THE DRAWINGS

The present invention is illustrated by way of example, and not by way of limitation, in the figures of the accompanying drawings, in which like reference numerals refer to similar elements and in which:

FIGS. 1A and 1B are top views of a plate according to a first embodiment of the first aspect of the invention;

FIG. 1C is a top view of a plate according to a variant of the first embodiment of the first aspect of the invention;

FIGS. 2A and 2B are top views of a plate according to further embodiments of the first aspect of the invention;

FIG. 3 is a perspective representation of an exploded view of at least a part of the capillary device according to an embodiment of the second aspect of the invention;

FIG. 4 is perspective view of a gas chromatograph according to an embodiment of the third aspect of the invention;

FIG. 5 is perspective view of the gas chromatograph illustrated on FIG. 4, this latter being embedded in an oven;

FIG. 6A is a sectional view showing the transversal section of the capillary column formed between two joined plates;

FIGS. 6B is a sectional view showing the longitudinal section of the capillary column at the level of a hole extending through a plate.

### DETAILED DESCRIPTION OF THE DRAWINGS

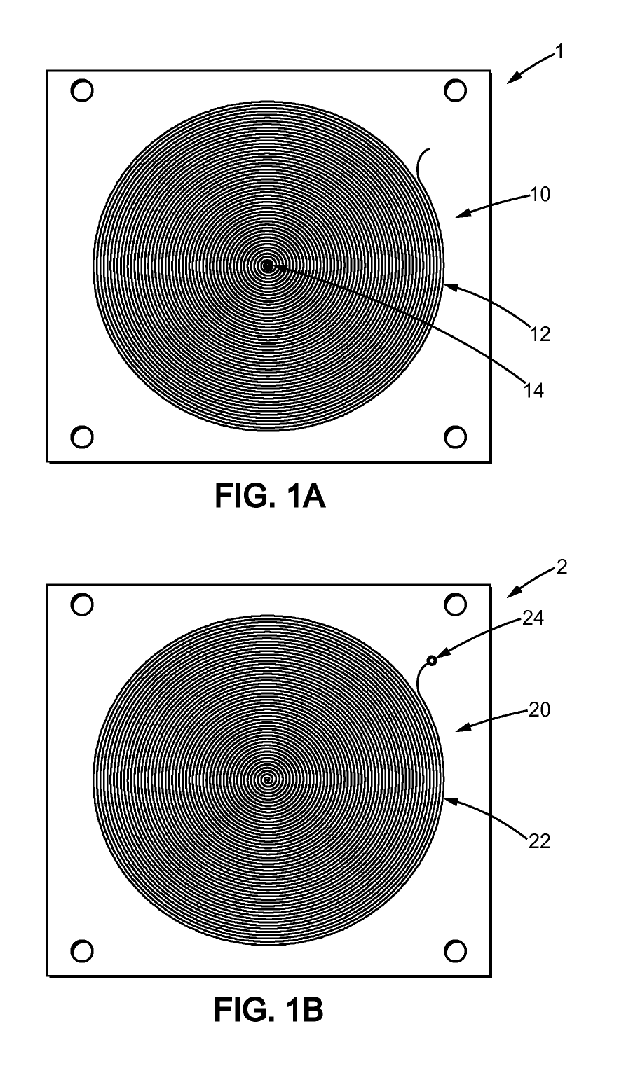

FIG. 1A and 1B are top views of a plate 1, 2 for gas chromatograph with a capillary column according to an embodiment of a first aspect of the invention.

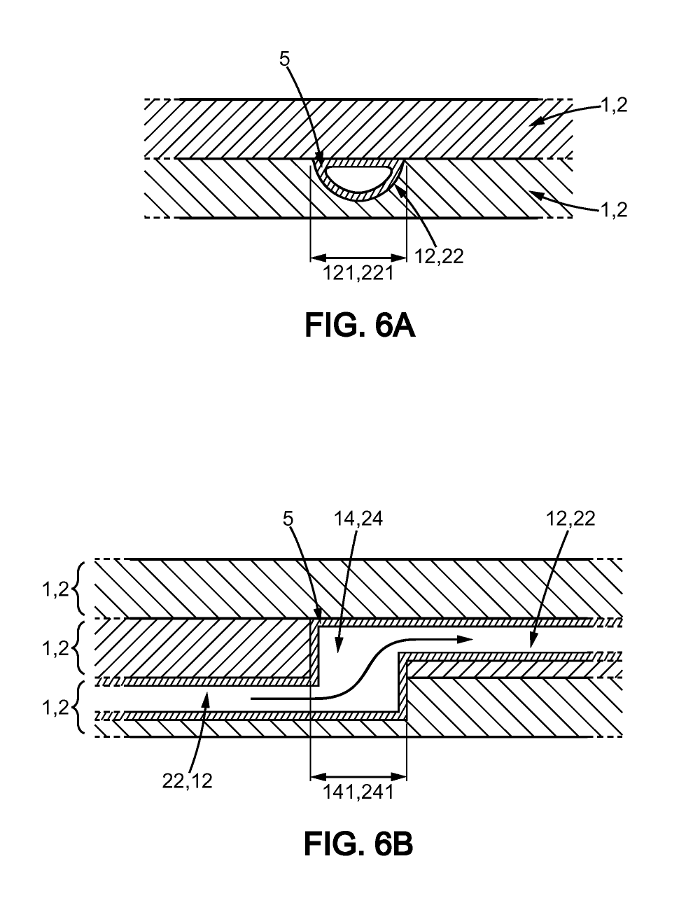

Each plate 1, 2 may be made of any material allowing the bonding of a stationary phase (referred to as numeral reference 5 on FIG. 6A and 6B) and having a suitable behavior under variations of temperature. Each plate is preferably made of a material with which the bonding of the stationary phase is favored and it is preferred that the bonding support of the stationary phase resists to the variations of temperature usually experienced during gas chromatography analysis (for instance from 40 to 300° C. or more).

A stationary phase is generally a microscopic layer of liquid or polymer on an inert solid support. Any conventional stationary phase polar or apolar, bonded or not may be used. For instance a silicone or fluorosilicone layer may be used.

Each plate 1, 2 may be more particularly made of glass, such as Pyrex, or made of metal, such as titanium, molybdenum or stainless steel, or made of metalloid, such as silicon.

It will be advantageous to alter the surface before bonding the stationary phase (e.g. for silicon, oxidation and formation of porous silicon).

Metal may be preferred to glass because of at least three reasons.

First, most of metals have more convenient behavior than glass under variations of temperature usually experienced during gas chromatography analysis. For instance, titanium is less sensitive than glass to quick temperature variations.

Second, most of metals are much more thermostable than glass notably at a pyrolysis temperature of the stationary phase. Pyrolysis of stationary phase may be used to recycle the capillary column. Thus a metallic plate may be more probably recycled and more usually reused than a glass plate after pyrolysis of the stationary phase; then the cost is advantageously reduced on several gas chromatography analyses. Moreover, covalent bonds tend to be formed between glass plates and a silica layer used as stationary phase, the covalent bonds being hard to break without damaging the glass plate.

Third, most of metals such as titanium allow to achieve a satisfactory homogeneity of the temperature in its bulk with comparison to glass. This may be of interest with respect to the quality of the gas chromatography analysis.

For a metallic plate, a metal having a low coefficient of thermal expansion may be preferred. For instance, titanium may be preferred to stainless steel because the coefficient of thermal expansion of titanium is less than the one of the stainless steel. Owing to its lower coefficient of thermal expansion, titanium as compared to stainless steel changes in volume in response to a change in temperature in a manner which interferes to a lesser extent with the dimension and/or the form of the capillary column at least during gas chromatography analysis or during pyrolysis of the stationary phase.

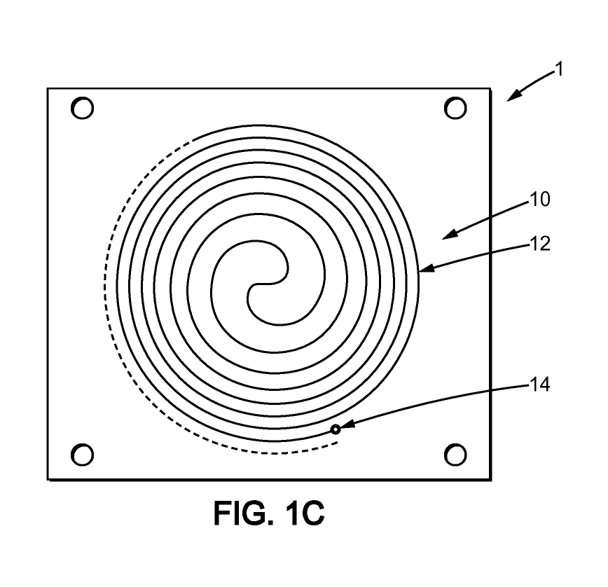

As illustrated on FIG. 2B, each plate 1, 2 has a greater dimension 11, 21 between 1 and 10 cm. For instance, the greater dimension 11, 21 of each plate 1, 2 is equal to 1.5 cm, 3 cm or 5 cm. The plate may be in the form of a disc, a rectangle, a square, a triangle or an ellipse. Preferably, the form of the plates 1, 2 may be chosen to achieve a homogeneous distribution of forces at their interface(s) when, as described below, the plates are closely stacked with each other.

As illustrated on FIG. 1A, 1B, 2A and 2B, each plate 1, 2 has at least one face 10, 20 on which at least one furrow 12, 22 is etched. Each furrow is a groove etched in the surface of the plate.

The etching of furrow may be carried out by using nanosecond to femtosecond laser in function of the material in which the plate is made. The etching may also be carried out by known mechanical or chemical etching techniques. Manufacturing methods of the etched plates may also comprise molding and metal 3D (three-dimensional) printing by using a metal 3D printer.

Each furrow 12, 22 forms at least a first part of the capillary column of the gas chromatograph. A film of the stationary phase may be intended to be coated at least on each furrow 12, 22.

A bottom of each furrow 12, 22 is preferably in the form of a semi-cylinder. In alternative embodiments, the transversal section of each furrow may be a U-shaped or V-shaped curve.

As illustrated on FIG. 6A, the transversal section of each furrow 12, 22 may have a greater internal dimension 121, 221 between 100 and 500 μm, preferably of 250 μm. For instance, when the furrow 12, 22 is in the form of a semi-cylinder, said greater internal dimension 121, 221 refers to the diameter of the semi-cylinder.

Each furrow 12, 22 has preferably a sinuosity index which is strictly greater than 1. Thus straight furrows are preferably excluded. The sinuosity index of a sine function (over a whole number of half-periods) can be calculated to be 1.216. The sinuosity index of each furrow is preferably higher than said sinuosity index of a sine function and more preferably higher than 10.

For instance, each furrow draws a spiral as illustrated on FIG. 1A, 1B and 1C or a meandering path as illustrated on FIG. 2A and 2B, or any kind of continuous non-straight path. For instance, the spiral is an Archimedean spiral as illustrated on FIG. 1A and 1B, a Fermat's spiral as illustrated on FIG. 1C, or any form approaching such spiraled forms. Such a furrow may occupy a great part of the face 10, 20 of the plate 1, 2 on which it is edged.

As illustrated in an example by a furrow comprising the continuous line plus the dashed line on FIG. 1C, the two ends of a furrow may be as close as possible from each other but without being connected between them. More generally, the distance between the ends of a furrow may tend to zero, resulting in an index of sinuosity tending towards infinity whatever the length of the furrow. The person skilled in the art aware of this mathematical singularity understands that the main technical feature to be protected by specifying an inferior threshold value for the sinuosity index of each furrow is that each furrow is preferably etched in the limited etching surface constituted by a face of each plate so as to be as long as possible and at least longer than any straight line.

The more the length of each furrow 12, 22 is the less the number of plates in the stack described below may be to form a capillary column having a suitable length. Typically, a suitable length of the capillary column is between 20 m to 150 m, preferably 25 m to 120 m, and according to a preferred embodiment of approximately 100 m. Each furrow 12, 22 may have a length between 20 cm and 10 m, more preferably higher than 50 cm.

As illustrated on FIG. 2B, a plurality of unconnected furrows 12, 22 may be etched on said at least one face 10, 20 of each plate 1, 2. More particularly, three unconnected furrows are partially illustrated on FIG. 2B. Each furrow of the plurality forms a first part of a capillary column of the gas chromatograph so that the gas chromatograph comprises a corresponding plurality of capillary columns. Advantageously, owing to such a gas chromatograph, a plurality of chromatographic analysis may thus be carried out in the same time. It should be noted that the two unconnected furrows may have the same length and that at least two unconnected furrows 12, 22 may also be etched on the same face 10, 20 with Archimedean spiraled furrows.

As illustrated on FIG. 2A, the meandering path 12, 22 drawn by the continuous line plus the dashed line has a rotational symmetry at least with respect to some 180° rotations. Thus, only one type of plates has advantageously to be manufactured to allow manufacturing of a capillary device as described below.

It should be noted that the plates 1, 2 intended to be disposed in contact to form a single capillary device are preferably etched with the same model of furrow 12, 22 at the same position of the plates 1, 2. Moreover, each furrow is preferably etched centrically on the face 10, 20 of each plate 1, 2.

As illustrated on FIG. 1A, 1B, 2A and 2B, each furrow 12, 22 extends by a hole 14, 24, preferably only one hole, through the plate 1, 2. Each hole is intended to be a part of the capillary column. More particularly, each through-hole 14, 24 may be intended to form a kind of meandering path of the capillary column.

As illustrated on FIG. 6B, an internal surface of each hole 14, 24 may be coated with a film of the stationary phase and the transversal section of each hole may have a greater internal dimension 141, 241 between 100 and 500 μm, preferably of 250 μm.

Each furrow 12, 22 has two ends. At least one end of a furrow may either extend until the perimeter of the plate 1, 2, thus resulting in an longitudinal opening of the furrow towards the outside of the plate at its perimeter, or may stop before joining the perimeter of the plate 1, 2. Preferably, both ends of a furrow 1, 2 stop before joining the perimeter of the plate 1, 2, as illustrated notably on FIG. 1A, FIG. 1B and FIG. 2A.

As illustrated on FIG. 6B, the hole 14, 24 through the plate 1, 2 may be an extension of at least one end of each furrow 12, 22, preferably of a single end of each furrow 12, 22.

As illustrated by the comparison between FIG. 1A and 1B, the single structural difference between the plate 1 and the plate 2 may consist in that the furrow 12 of plate 1 extends by a hole 14 at the end of the furrow 12 which is centric with respect to the spiral drawn by the furrow, whereas the furrow 22 of plate 2 extends by a hole 24 at the end of the furrow 22 which is eccentric with respect to the spiral drawn by the furrow.

It should be noted that, in the case illustrated on FIG. 2A where the meandering path 12, 22 is drawn by the continuous line plus the dashed line, the rotational symmetry with respect to some 180° rotations still remains when at least one end of the furrow 12, 22 extends by a hole 14, 24 through the plate.

In this case, with the assumption that the furrow 12, 22 of each plate is etched centrically on the face 10, 20, the plates of a capillary device as described hereafter are rigorously identical to each other, thus providing manufacturing simplification. The same is true for the case illustrated on FIG. 1C (without taking into account the dashed line).

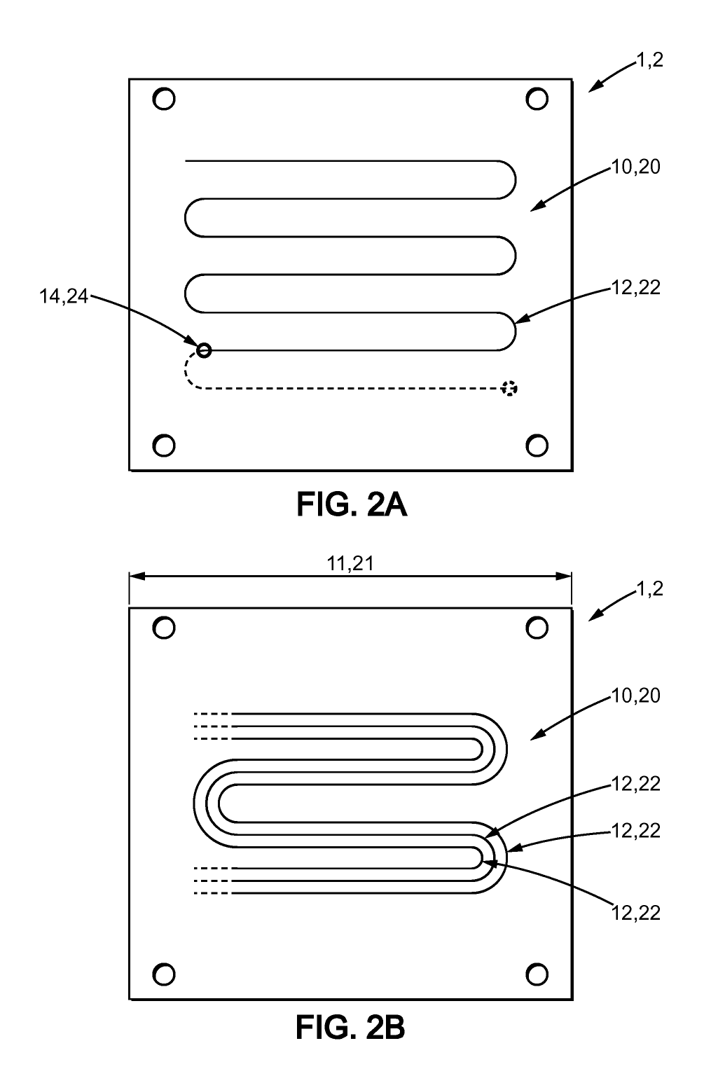

FIG. 3 is a perspective representation of an exploded view of at least a part of the capillary device 4 according to an embodiment of the second aspect of the invention.

The capillary device 4 comprises a first plate 1, 2 as described above and a second plate. An etched face 10, 20 of the first plate 1, 2 is intended to be in contact with a face of the second plate. At least one portion of said face of the second plate, for instance the face portion of the second plate which is opposite to the furrow of the etched face 10, 20 of the first plate 1, 2, is intended to form a second part of each capillary column. The second part of each capillary column may be coated with a film of the stationary phase 5, as illustrated on FIG. 6A and 6B.

The second plate may be either a plate 1, 2 as described above, or an end plate.

Said end plate may not comprise an etched face, but may be merely an ordinary plate, for instance with unetched or strictly flat faces. The end plate may comprise a through hole forming an opening towards the furrow of the plate 1, 2 with which the end plate is intended to be in contact. The end plate may not be intended to be in contact with another plate than the first one 1, 2; that is to say that the face of the end plate which is opposite to the face intended to be in contact with the first plate 1, 2 may not be intended to be in contact with another plate.

No end plate is represented notably on FIG. 3. Nonetheless, if, as illustrated on FIG. 3, the upper face of each plate 1, 2 to be stacked is etched, then an end plate may suitably constitute an uppermost plate of the stack.

When the second plate is a plate 1, 2, with at least one furrow 12, 22 of the first plate 1, 2 extending by a hole 14, 24 at least through the first plate 1, 2, said hole 14, 24 joins a furrow 12, 22 etched on a face 10, 20 of the second plate 1, 2.

According to the embodiment illustrated on FIG. 3, with each plate having a spiraled furrow, it is shown how the stack of alternate plates 1 and 2 makes it possible to form a capillary device 4 comprising the capillary column.

For instance, starting, as illustrated by the arrow marked with “IN” on FIG. 3, from a plate 2 as the lowermost plate of the stack, the capillary column begins at its hole 24 and extends from this hole 24 through the furrow 22 etched on the upper face 20 of said lowermost plate until reaching the centric end of this furrow, where the capillary column extends through a hole 14 of the successively higher plate 1 of the stack and extends from this hole 14 through the furrow 12 etched on the upper face 10 of said successively higher plate until reaching the eccentric end of this furrow, where the capillary column extends through a hole 24 of the successively higher plate 2 of the stack and extends from this hole 24 through the furrow 22 etched on the upper face 20 of said successively higher plate of the stack until reaching the centric end of this furrow, where the capillary column extends through a hole 14 of the successively higher plate 1 (the uppermost represented plate on FIG. 3) and extends from this hole 14 through the furrow 12 etched on the upper face 10 of said successively higher plate until reaching the eccentric end of this furrow to join the arrow marked with “OUT” on FIG. 3. Instead of finishing the stack as illustrated by the “OUT” arrow, the stack may go on with a successively higher plate 2, then a successively higher plate 1, and so on.

The first plate 1, 2 and the second plate of the capillary device 4 are closely joined. More particularly, each plate of the stack is closely joined with each contacting plate of the stack. The join between successive plates of the stack may be realized by gluing, welding, for instance by using magnetic impulses, or mechanically tightening, for instance with a bolt (not represented) crossing the stack through holes made into coins of the plates, said holes being as illustrated on FIG. 1A, 1B, 2A, 2B and 3, and cooperating with a corresponding nut (not represented).

The join between successive plates of the stack is preferably such that each capillary column is transversally tight to a carrier gas. In gas chromatography, the carrier gas is the mobile phase. The carrier gas may usually be an inert gas, such as helium, or an unreactive gas, such as nitrogen. Each capillary column may also be transversally tight to hydrogen.

The capillary device 4 thus obtained has a capillary column whose the length is approximately the addition of the length of the furrows of the stacked plates.

According to an embodiment of the manufacturing method of the capillary device 4, once the stacked plates are joined and thus at least one capillary column is formed, the stationary phase 5 is injected or bonded into said at least one capillary column to be deposited on their inner walls. Thus, as illustrated on FIG. 6A and 6B, the stationary phase 5 continuously coats each furrow 12, 22 (more particularly the bottom surface of each furrow), each face portion of the successive plate 1, 2 in the stack which is opposite to a furrow 12, 22 and the internal surface of each hole 14, 24.

Advantageously, the capillary device 4 has thus reduced dimensions, e.g. occupying few cm³ only instead of few dm³ for a laboratory gas chromatograph, but having a capillary column with conventional dimensions with respect to a laboratory gas chromatograph, e.g. 100 m length×0.25 mm i.d. (internal diameter). For instance, a 10 meters length capillary column could be put in a 1.5 cm×1.5 cm×1.5 cm capillary device 4, a 50 meters length capillary column could be put in a 2 cm×2 cm×2 cm capillary device 4, and a 100 meters length capillary column could be put in a 3 cm×3 cm×3 cm capillary device 4. These given examples correspond to cubic capillary device 4, but the here described capillary device is not limited thereto. Two dimensions of the capillary device 4 depend mainly on the dimensions of the face of the plates and the third one depends mainly on the number of plates in the stack and on the thickness of each plate of the stack.

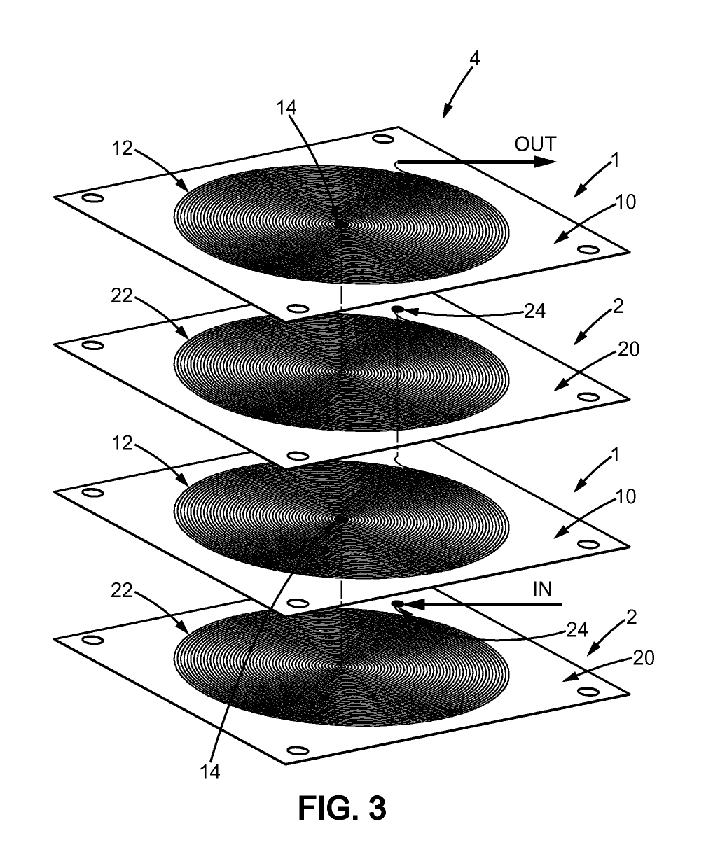

As illustrated on FIG. 4, in order to achieve a gas chromatograph 6, the capillary device 4 may be arranged at least with an injection unit illustrated on the right side of the capillary device 4 and with a detection unit illustrated on the left side of the capillary device 4. The injection unit is a conventional one. The detection unit is also conventional and may comprise for instance a mass spectrograph. Pressure regulation and electronic controls are conventional.

Such a gas chromatograph 6 takes advantage of the reduced dimensions of the capillary device 4 to be at the same time portable and capable of the same analysis capacities than a laboratory gas chromatograph.

It is thus provided a gas chromatograph 6 designed not only for field operation (on-site or on-line), but also for in-lab complex hydrocarbon mixtures analysis (C1 to C40+). Moreover, the size of the capillary device 4, and thus the size of the gas chromatograph 6, may be compatible with bottom hole measurements. Furthermore, the gas chromatograph 6 may also be used in various technical fields, such that for environment purposes since it could be applied to the analysis of pollutants, for chemical and pharmaceutical technical domains since it could be applied to the analysis of fragrances, medicines and the like, for fighting against drugs, since it could be applied to the analysis of drugs, and so on.

Moreover such a gas chromatograph 6 allows to be used with lower electricity consumption and avoids the use of chromatographic oven.

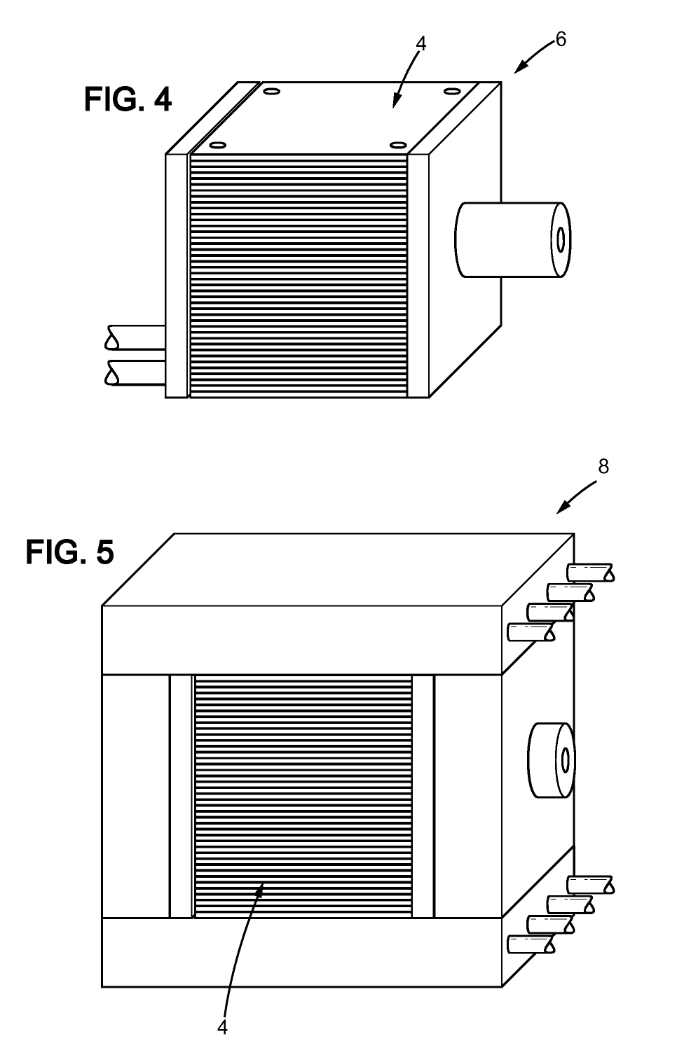

Indeed, as illustrated on FIG. 5, some thermoelectric devices using e.g. the Peltier effect may be advantageously arranged around the capillary device 4 to form an oven used to warm the capillary device 4. For instance, when the capillary device 4 is cubic, six thermoelectric devices may be respectively arranged against the six faces of the capillary device 4. It should be noted that, on FIG. 5, at least one thermoelectric device, the one which should be arranged on the front face of the illustrated capillary device 4, is not represented so that the capillary device 4 is shown.

Thus the gas chromatograph 6 and the oven 8 as a whole have dimensions and weight allowing its carriage and operation on a drone, a plane, an helicopter, a land vehicle, a ship, and so on.

Eventually, the gas chromatograph 6 and the oven 8 as a whole may easily comply with security requirements, such that the ATEX directive.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the invention.

For example, the thickness of the plates may vary or on the contrary may be constant;

the thickness of a plate 1, 2 may be two times or three times the depth of the etched furrow 12, 22.

The lowermost plate and the uppermost plate of the stack may be of greater thickness than the other plates of the stack for imparting rigidity to the structure during the assembly of individual plates or during their temperature rise during the analysis.

For another example, each plate or some of them may be etched with a furrow on their two faces, with a furrow etched on a face of a plate being arranged to be opposite to the furrow etched on the face of a contacting plate; thus the capillary column may have a circular transversal section.

1. The plate for gas chromatograph with a capillary column wherein at least one face of the plate is etched with a furrow forming a first part of the capillary column,

2. The plate according to claim 1, wherein a plurality of unconnected furrows is etched on the same face of the plate, each furrow forming a first part of a capillary column.

3. The plate according to claim 1, wherein each furrow has a sinuosity index which is strictly greater than 1.

4. The plate according to claim 1. wherein a transversal section of each furrow has a greater internal dimension between 100 and 500 μm.

5. The plate according to claim 1, wherein the plate has a greater dimension between 1 and 10 cm.

6. The plate according to claim 1, wherein each furrow extends by a hole through the plate, each hole forming a part of the capillary column.

7. The plate according to claim 1, wherein at least each furrow is coated with a film of stationary phase.

8. The plate according to claim 7, wherein the plate is made of a material thermostable at least at a pyrolysis temperature of the stationary phase.

9. The plate according to claim 1, wherein the plate is made of a material having a coefficient of thermal expansion less than the one of the stainless steel.

10. A capillary device comprising a first plate and a second plate, wherein an etched face of the first plate is in contact with a face of the second plate, at least one portion of said face of the second plate forming a second part of each capillary column.

11. The capillary device according to claim 10, wherein at least the second part of each capillary column is coated with a film of stationary phase.

12. The capillary device according to claim 10, wherein the first plate and the second plate of the device are closely joined so that each capillary column is transversally tight to a carrier gas.

13. The capillary device according to claim 10, wherein, at least one furrow of the edged face of the first plate extending by a hole at least through the first plate, said hole joins a furrow etched on a face of the second plate.

14. The capillary device according to claim 13, wherein the transversal section of each hole has a greater internal dimension between 100 and 500 μm and wherein an internal surface of each hole is coated with a film of stationary phase.

15. A gas chromatograph comprising a capillary device comprising a first plate and a second plate, wherein an etched face of the first plate is in contact with a face of the second plate, at least one portion of said face of the second plate forming a second part of each capillary column.
